(19) United States
(12) Patent Application Publication
(10) Pub. No.: US 2021/0214134 A1
(43) Pub. Date: Jul. 15, 2021

(54) CHILD RESISTANT BOTTLE

(71) Applicant: Contempo Card Company, Providence, RI (US)

(72) Inventor: Michael Markarian, Tiverton, RI (US)

(21) Appl. No.: 17/209,908

(22) Filed: Mar. 23, 2021

Related U.S. Application Data
(63) Continuation-in-part of application No. 16/903,987, filed on Jun. 17, 2020.
(60) Provisional application No. 62/993,341, filed on Mar. 23, 2020.
(60) Provisional application No. 62/862,461, filed on Jun. 17, 2019.
(60) Provisional application No. 62/959,097, filed on Jan. 9, 2020.

(51) Int. Cl. B65D 50/06; B65D 41/16; B65D 43/02

(52) U.S. Cl. CPC B65D 50/061; B65D 41/16; B05B 11/30; B65D 2215/04; B65D 43/0212

(57) ABSTRACT

A child resistant bottle includes a lower portion, the lower portion including a neck, the lower portion including a reservoir, and an upper portion, the upper portion adapted to press fit over the neck of the lower portion, the upper portion covering a pump mechanism, an outer diameter of the lower portion equaling an outer diameter of the upper portion, the upper portion configured to rotate about the neck of the lower portion, the upper portion including an upper alignment feature, the lower portion including a lower alignment feature.

### CROSS-REFERENCE TO RELATED APPLICATIONS

This application is a Continuation-in-Part (CIP) of U.S. patent application Ser. No. 16/903,987, filed Jun. 17, 2020, which claims benefit from U.S. Provisional Patent Application Ser. No. 62/862,461, filed Jun. 17, 2019, U.S. Provisional Patent Application Ser. No. 62/959,097, filed Jan. 9, 2020, and U.S. Provisional Patent Application Ser. No. 62/993,341, filed Mar. 23, 2020, each of which is incorporated by reference in its entirety.

### BACKGROUND OF THE INVENTION

The invention generally relates to containers, and more specifically to a child resistant bottle.

In general, solutions, whether over-the-counter or prescription, are often dispensed from bottles with caps that include a child resistant feature that reduces the risk of an unsupervised child accidentally overdosing or otherwise ingesting the solution. While the child resistant cap is difficult for children to open, it is often difficult for many adults to open as well. For example, senior citizens may lack the strength or dexterity required to open the child resistant cap. In addition, many adults may have arthritis or some other physical condition that makes it difficult for them to open a child resistant cap.

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a child resistant bottle including a lower portion, the lower portion including a neck, the lower portion including a reservoir, and an upper portion, the upper portion adapted to press fit over the neck of the lower portion, the upper portion covering a pump mechanism.

In another aspect, the invention features a child resistant bottle including a lower portion, the lower portion including a neck, the lower portion including a reservoir, and an upper portion, the upper portion adapted to press fit over the neck of the lower portion, the upper portion covering a pump mechanism, an outer diameter of the lower portion equaling an outer diameter of the upper portion, the upper portion configured to rotate about the neck of the lower portion, the upper portion including an upper alignment feature, the lower portion including a lower alignment feature.

In still another aspect, the invention features a child resistant bottle including a child-proof pump assembly, and a base assembly, the child-proof pump assembly configured to permanently secure to the base assembly.

The invention may include one or more of the following advantages.

The child resistant bottle includes a top cap that locks to a neck of a pump mechanism and can only be removed with a “line up the half circles and release” function.

The pump mechanism locks to a neck of the bottle and cannot be removed.

The child resistant bottle can be manufactured in many sizes and from a multitude of materials, including, for example, glass, PP, eco additives, bio polymers, and so forth.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary child resistant bottle.

FIG. 2 is a top view of the exemplary child resistant bottle.

FIG. 3 is a bottom view of the exemplary child resistant bottle.

FIG. 4 illustrates the upper portion locked on the lower portion.

FIG. 5 illustrates feature alignment.

FIG. 6 illustrates a pop out tab.

FIGS. 7A and 7B illustrate lower alignment features.

FIG. 8 illustrates a pump mechanism.

FIGS. 9A, 9B and 9C illustrate tabs.

FIG. 10 illustrates a treatment pump mechanism.

FIG. 11 illustrates a rotating side nozzle mechanism.

FIG. 12 illustrates a screw on straw with holder mechanism.

FIG. 13 illustrates an exemplary child resistant pump mechanism to a bottle connection.

FIG. 14 illustrates an exemplary child resistant cap.

FIG. 15 illustrates other implementations, such as a roll-on mechanism.

FIG. 16 illustrates an exemplary two-piece child-proof bottle.

FIG. 17 is a flow diagram.

FIG. 18 illustrates an exemplary fully assembled child-proof bottle.

FIG. 19 illustrates the two components of an exemplary child-proof bottle.

FIG. 20 illustrates components of an exemplary cap assembly separated from an exemplary base assembly.

FIG. 21 illustrates exemplary component of an exemplary two-piece child-proof bottle.

FIG. 22 illustrates another embodiment of an exemplary two-piece child-proof bottle.

FIG. 23 illustrates exemplary parts of the two-piece child-proof bottle of FIG. 22.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

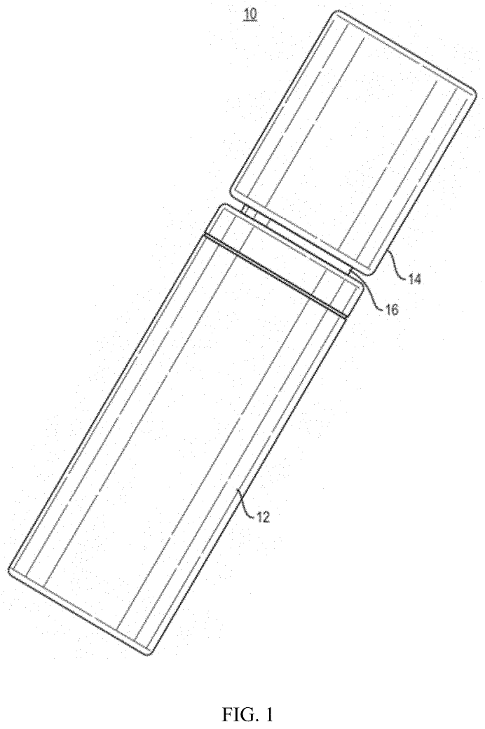

As shown in FIG. 1, an exemplary child resistant bottle 10 includes a lower portion 12 and an upper portion 14. The upper portion 14 is adapted to fit over a neck 16 of the lower portion 14. The upper portion includes, for example, a pump mechanism, described below. In one embodiment, the upper portion 14 is pressed on to the neck 16, which is not threaded. Once positioned and pressed on to the neck 16, the upper portion 14 is affixed to the lower portion 12.

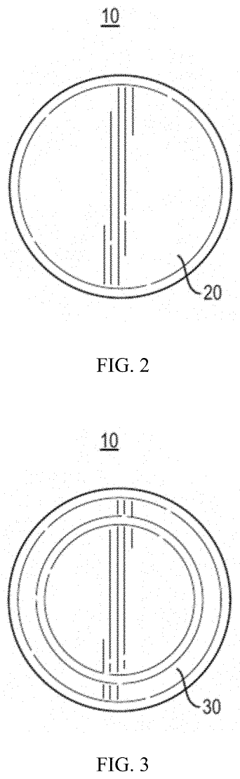

In a preferred embodiment, an outer diameter of the lower portion 12 is the same as an outer diameter of the upper portion 14. This is more clearly shown in FIG. 2, which illustrates a top view of the child resistant bottle 10 and in FIG. 3, which illustrates a bottom view of the child resistant bottle 10. More specifically, the view shown in FIG. 2 is a top 20 of the upper portion 14 and the view shown in FIG. 3 is a bottom of the lower portion 12.

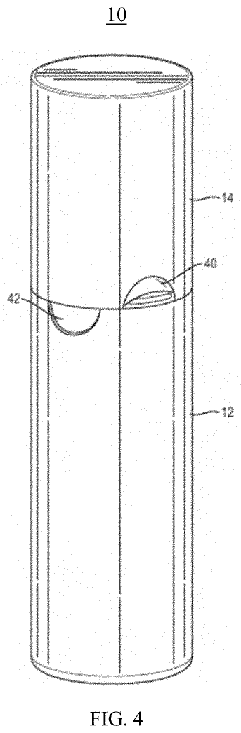

In FIG. 4, the upper portion 14 is shown locked on the lower portion 12. When in this locked position, the upper portion 14 is configured to rotate about the lower portion 12. The upper portion 14 includes an upper alignment feature 40 and the lower portion includes a lower alignment feature 42. The upper alignment feature 40 and the lower alignment feature 42 are used to release the upper portion 14 from the lower portion 12 and to prevent accidental removal of the upper portion 14 from the lower portion.

In the configuration shown in FIG. 4, the upper alignment feature 40 and the lower alignment feature 42 are not aligned with each other. In such a configuration, the upper portion 14 and locked and cannot be removed from the lower portion 12.

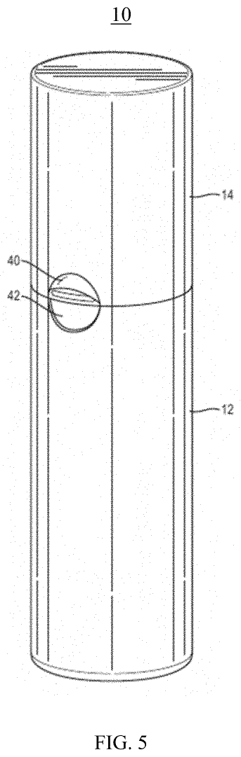

As shown in FIG. 5, the upper portion 14 has been rotated about the lower portion 12 such that the upper alignment feature 40 and the lower alignment feature 42 are aligned with each other. Such a configuration enables removal of the upper portion 14 from the lower portion 12.

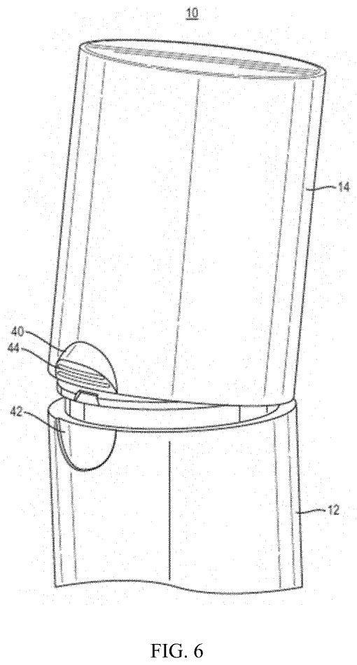

As shown in FIG. 6, when the upper alignment feature 40 and the lower alignment feature 42 are aligned with each other, pressing a pop out tab 44 in the upper alignment feature 40 releases the upper portion 14 from the lower portion 12.

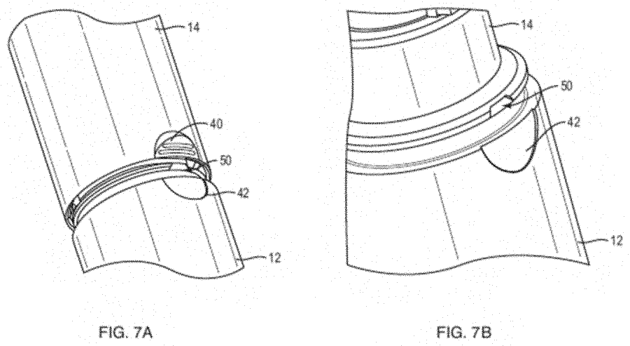

More specifically, as shown in FIGS. 7A and 7B, a detail on the lower alignment feature 42 enables a small tab 50 to pop out of the upper feature 40 of the upper portion 14.

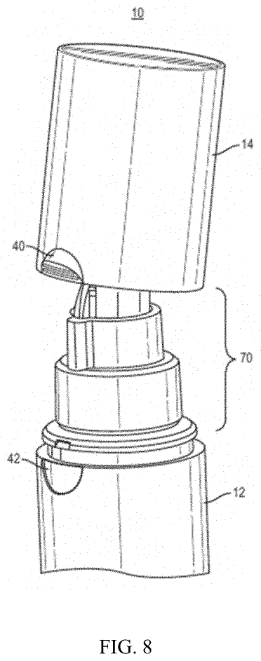

As shown in FIG. 8, as the upper portion 14 is lifted off the lower portion 12, a pump mechanism 70 is exposed and ready for use. More specifically, the pump mechanism 70, in this implementation, is used to spray a content of liquid stored in the lower portion 12.

As described above, in one embodiment, the pump mechanism 70 is included within the upper portion 14 such that when the upper portion 14 is pressed into the lower portion 12 the pump mechanism 70 is secured within the lower portion 12 and the upper portion 14 minus the pump mechanism 70 may be removed from the lower portion 12 when the upper alignment feature and the lower alignment feature are aligned with each other, exposing the pump mechanism 70.

In another embodiment, the pump mechanism 70 is not included in the upper portion 14. In one implementation, the pump mechanism 70 is permanently pressed on to the neck of the lower portion 12 and the upper portion 14 secured to the lower portion 12 over the pump mechanism 70.

In another implementation, the pump mechanism 70 is screwed on to the neck of the lower portion 12 and the upper portion 14 secured to the lower portion 12 over the pump mechanism 70. In this implementation, if necessary, the pump mechanism 70 may be unscrewed and removed from the lower portion 12.

In another implementation, the pump mechanism 70 includes a pump mechanism alignment feature (not shown). In this implementation, the pump alignment feature must align with an alignment feature on the lower portion 12 in order to be removed.

The implementations above illustrate a number of variations that are possible with the child resistant bottle. These variations include, for example:

1. A threaded bottle plus non child resistant ring around the nozzle and a child resistant overcap that connects to the bottle (not to the ring).

2. A threaded bottle plus non child resistant ring around nozzle but the ring locks in place so it cannot be removed once screwed on with child resistant overcap that connects to the bottle that encloses the nozzle (not to the ring)

3. A threaded bottle plus ring around nozzle that is child resistant, meaning it could be removed by push and turn or other child resistant opening method such as quarter turn lock with child resistant overcap that connects to the bottle (not to the ring) and encloses the nozzle.

4. A threaded bottle plus a cap with a child resistant ring around nozzle and a child resistant overcap which connects to the child resistant ring (not the bottle).

5. A non-threaded bottle plus a nozzle fixture and child resistant overcap that locks into the nozzle fixture, and then that snaps directly into the bottle, so only the child resistant overcap can be removed from the nozzle fixture but the nozzle fixture cannot be removed.

For attachment to a threaded bottle, one needs a ring, a nozzle and a cap.

For attachment to a non-threaded bottle (e.g., press fit/snap fit, and so forth), no ring is needed. There would be an additional plastic piece (e.g., circular piece) connected to nozzle that swedges into the mouth of the bottle.

A non-child resistant bottle can be threaded or otherwise (i.e., the nozzle/ring can be child resistant in that it still takes a certain amount of force to remove).

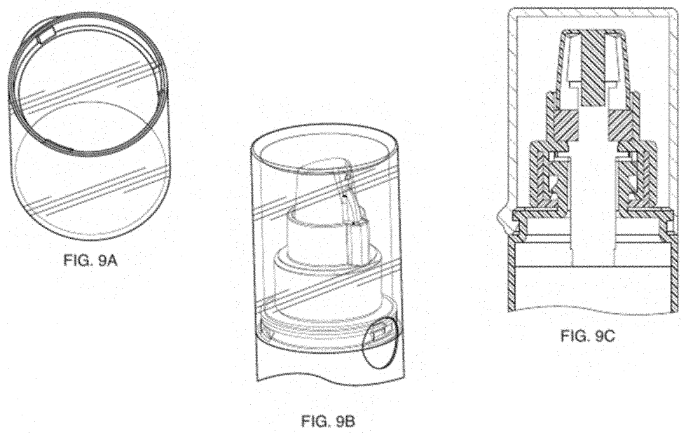

As shown in FIGS. 9A, 9B and 9C, there are three internal tabs in the upper portion 14 that engage with a groove in the lower alignment feature of the lower portion 12; one tab is smaller than the other two tabs. The smaller is located by the arrow.

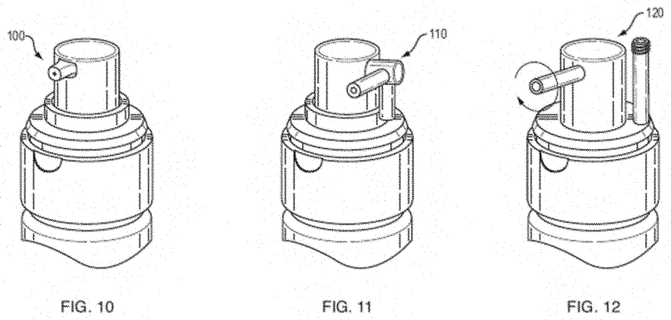

As described above, when upper portion 14 is removed a pump mechanism 70 is exposed. Different pump mechanisms may be included. For example, FIG. 10 illustrates a treatment pump mechanism 100, FIG. 11 illustrates a rotating side nozzle mechanism 110 and FIG. 12 illustrates a screw on straw with holder mechanism 120. Other implementations may include other mechanisms, such as a roll-on mechanism (e.g., deodorant mechanism), for example.

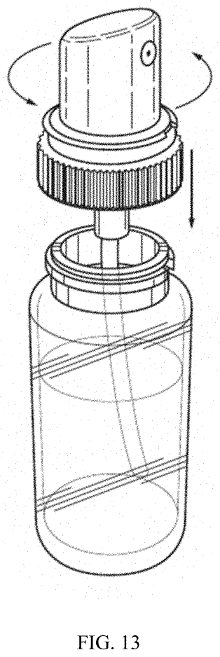

FIG. 13 illustrates a child resistant pump mechanism to a bottle connection. To remove, push collar down and unscrew.

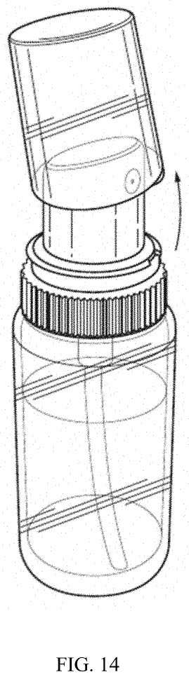

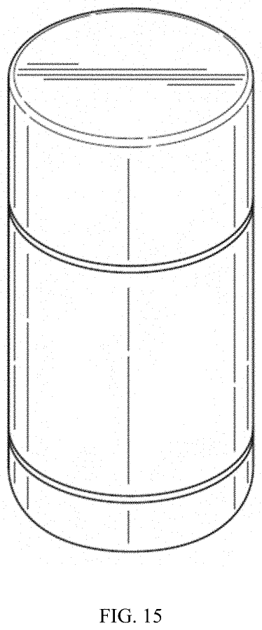

FIG. 14 illustrates a child resistant cap. To remove, align lift bump and pry off cap.

FIG. 15 illustrates other implementations, such as a roll-on mechanism.

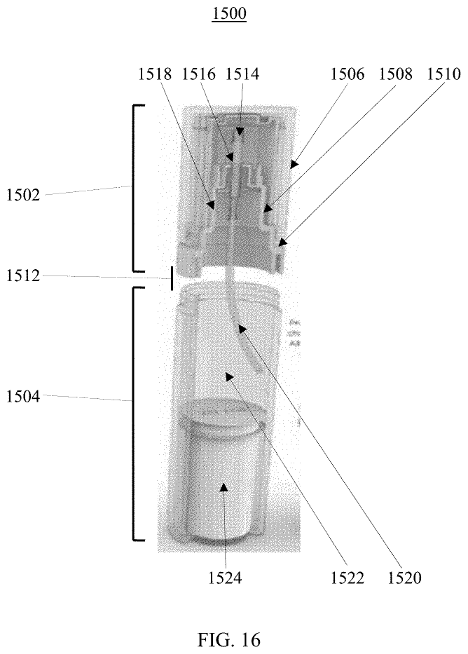

As shown in FIG. 16, a cross-section of an exemplary two-piece child resistant bottle 1500 include cap assembly 1502 and a base assembly 1504. The cap assembly 1502 includes a cap 1506 and a pump assembly 1508 that secured together using a child-proof locking mechanism 1510. The cap assembly 1502 is configured to permanently secure to the base assembly 1504 using a press fit 1512.

In the embodiment illustrated, the pump assembly 1508 includes a nozzle 1514, a neck 1516, a pump engine 1518 and a dip stem 1520. In other embodiments, the pump assembly 1508 includes an air pump.

The base assembly 1504 includes a cavity 1522 configured to house a fluid. In one specific embodiment, the cavity 1522 includes a plug 1524. A size of the plug 1524 is used to set a volume of fluid housed in the cavity 1522.

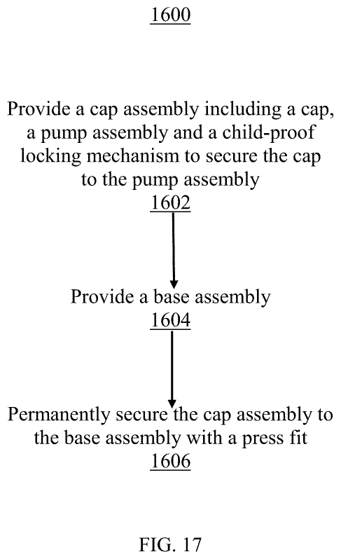

As shown in FIG. 17, a process 1600 includes providing (1602) a cap assembly including a cap, a pump assembly and a child-proof locking mechanism to secure the cap to the pump assembly.

Process 1600 includes providing (1604) a base assembly.

Process 1600 includes permanently securing (1606) the cap assembly to the base assembly with a press fit.

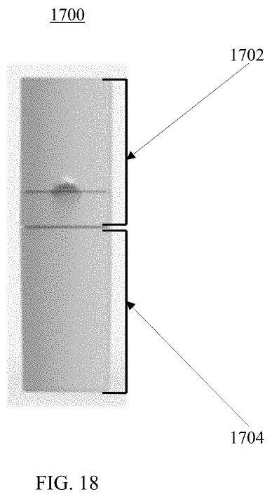

In FIG. 18, an exemplary fully assembled two-piece child-proof bottle 1700 is illustrated. More specifically, a cap assembly 1702 is permanently press fitted to a base assembly 1704.

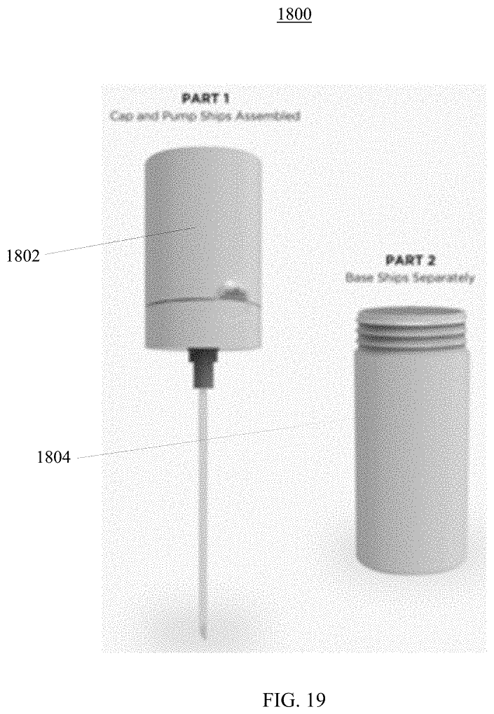

In FIG. 19, an exemplary two-piece child-proof bottle 1800 is shown with a cap assembly 1802 and base assembly 1804 separated.

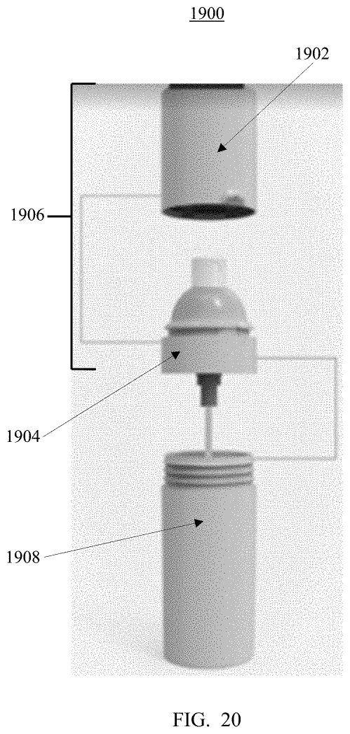

In FIG. 20, an exemplary two-piece child-proof bottle 1900 includes a cap 1902 and pump assembly 1904 that make up a cap assembly 1906. In a preferred embodiment, the cap 1902 and pump assembly 1904 are joined by a child-proof locking mechanism and then press fit to a base assembly 1908.

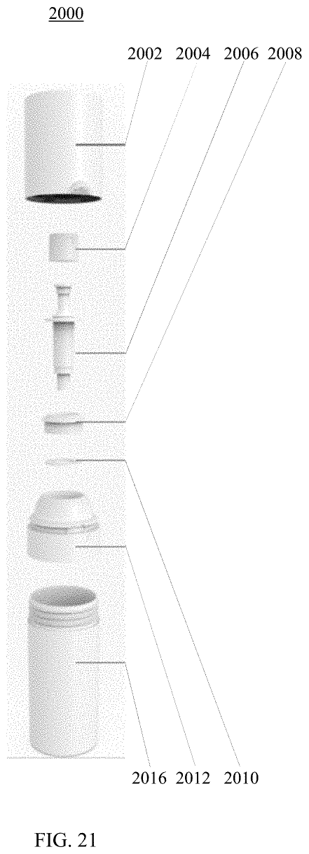

As shown in FIG. 21, an exemplary two-piece child-proof bottle 2000 includes a cap 2002, a nozzle 2004, a pumping tube 2006, a collar 2008, a gasket 2010 and locking unit 2012, all of which are included together as a cap assembly 2014. The locking unit 2012 is used to permanently lock the cap assembly 2014 on to a base unit 2016. In embodiments, the nozzle 2004 may be a spray nozzle, a lotion pump, or any other dispensing method using in the bottle, container, or packaging business.

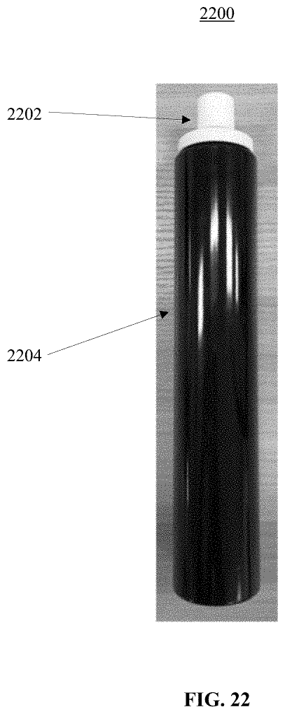

As shown in FIG. 22, an alternate embodiment of an exemplary two-piece child-proof bottle 2200 includes a child-proof proof pump assembly 2202 permanently secured to a base assembly 2204.

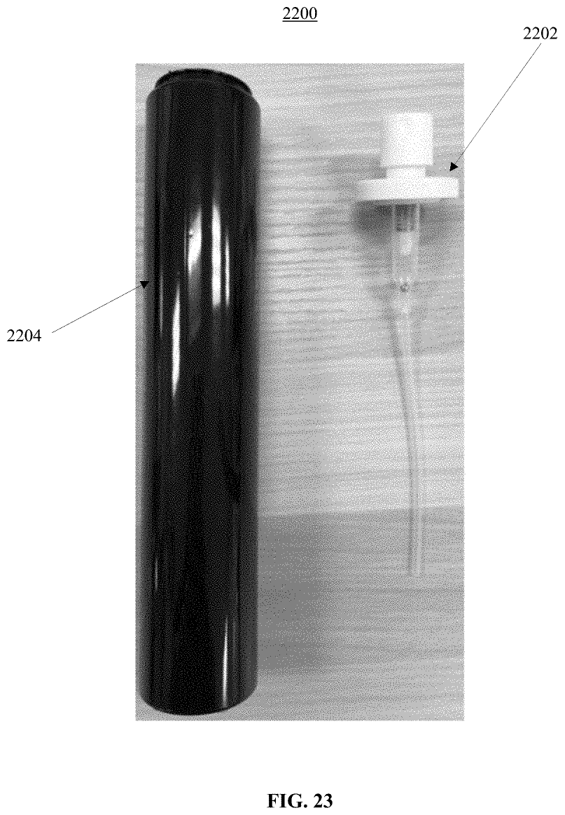

As shown in FIG. 23, the child-proof proof pump assembly 2202 is configured to be positioned over the base assembly 2204 and be pressed on to the base assembly 2204. Once pressed on to the base assembly 2204, the child-proof proof pump assembly 2202 is permanently secured to it.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed:

1. A child resistant bottle comprising:
a cap assembly comprising a cap, a pump assembly and a child-proof locking mechanism to secure the cap to the pump assembly; and
a base assembly, the cap assembly configured to permanently secure to the base assembly with a press fit.

2. The child resistant bottle of claim 1 wherein the pump assembly comprises:
a nozzle;
a neck;
a pump engine; and
a dip stem.

3. The child resistant bottle of claim 1 wherein the pump assembly comprises an airless pump system.

4. The child resistant bottle of claim 1 wherein the base assembly includes a cavity.

5. The child resistant bottle of claim 4 wherein the cavity is configured to house a fluid.

6. The child resistant bottle of claim 4 wherein the cavity includes a plug.

7. The child resistant bottle of claim 6 wherein a size of the plug sets a volume of fluid housed in the cavity.

8. A method comprising:
providing a cap assembly comprising a cap, a pump assembly and a child-proof locking mechanism to secure the cap to the pump assembly;
providing a base assembly; and
permanently securing the cap assembly to the base assembly with a press fit.

9. The method of claim 8 wherein the pump assembly comprises:
a nozzle;
a neck;
a pump engine; and
a dip stem.

10. The method of claim 8 wherein the pump assembly comprises an airless pump system.

11. The method of claim 8 wherein the base assembly includes a cavity.

12. The method of claim 11 wherein the cavity is configured to house a fluid.

13. The method of claim 11 wherein the cavity includes a plug.

14. The method of claim 13 wherein a size of the plug sets a volume of fluid housed in the cavity.

15. A child resistant bottle comprising:
a child-proof pump assembly; and
a base assembly, the child-proof pump assembly configured to permanently secure to the base assembly.

16. The child proof bottle of claim 15 wherein the child-proof pump assembly comprises:
a nozzle;
a neck;
a pump engine; and
a dip stem.

17. The child resistant bottle of claim 15 wherein the base assembly includes a cavity.

18. The child resistant bottle of claim 17 wherein the cavity is configured to house a fluid.
